(19) United States
(12) Patent Application Publication
(10) Pub. No.: US 2025/0388165 A1
(43) Pub. Date: Dec. 25, 2025

(54) Light System With Accessible Wire Harness

(71) Applicant: Valeo Vision, Bobigny (FR)

(72) Inventors: Don Hodnett, Troy, MI (US); Kevin Koons, Troy, MI (US); Yunfei Wang, Troy, MI (US)

(21) Appl. No.: 18/749,162

(22) Filed: Jun. 20, 2024

(51) Int. Cl. B60Q 1/00; B60R 16/02; F21S 41/141; F21S 41/19; F21S 41/29; F21V 23/00; F21V 23/06; F21Y 115/10

(52) U.S. Cl. CPC B60Q 1/0088; B60R 16/0207; F21S 41/141; F21S 41/192; F21S 41/29; F21V 23/001; F21V 23/06; F21Y 2115/10

(57) ABSTRACT

A light system for a vehicle comprising a housing with an opening extending therethrough, a wire harness that extends through the opening, and a cover connector comprising one or more housing fasteners that engage the housing and secure the cover connector to the housing such that the opening is sealed by the cover connector and one or more connector fasteners that engage the wire harness and secure the cover connector to the wire harness such that the wire harness electrically accessible through the cover connector while the cover connector is secured to the housing.

### TECHNICAL FIELD

This disclosure relates generally to a light system of a vehicle, and more particularly to openings and covers that enable a wire harness within the light system to be connected to or extend through a housing of the light system after the light system is otherwise assembled.

### BACKGROUND

Designs for the light systems (e.g., headlights) of vehicles are often influenced or controlled by the manufacturing processes used to make or assemble the light systems. Accordingly, there is a need for light systems that support or enable alternative assembly methods and, thereby, support or enable alternative or diverse designs for the light systems.

### SUMMARY

The teachings herein relate to a light system of a vehicle. The light system may include a housing, a lens subassembly, a wire harness, and a cover connector. The housing may include at least one opening. The opening may extend through the housing. The lens subassembly may be secured to the housing. The lens subassembly may include powered subcomponents such as an LED subsystem that may be removeable from the lens subassembly. The lens subassembly may include one or more lenses, one or more reflectors, and a heat sink.

The wire harness may include one or more electrical conductors that extend through the opening. The wire harness may connect to the at least one powered subcomponent. In operation, the wire harness may conduct electricity from the electrical system of a vehicle to the powered subcomponent. The wire harness may have a length sufficient to extend out of the opening of the housing when the cover connector is detached from the housing. Accordingly, the wire harness may be accessible while or after the lens subassembly is secured to the housing. The wire harness may be accessible for connection with an electrical system of the vehicle while the cover connector is attached to the housing.

The light system may also include a lens subassembly. The lens subassembly may be secured (e.g., fastened, welded, bonded using a sealant or adhesive, etc.) to the housing. The lens subassembly may include one or more lenses, one or more reflectors, and a heat sink.

The light system may include a powered subcomponent. The powered subcomponent may be connected to the wire harness. The wire harness may extend from the powered subcomponent. The powered subcomponent may be a part of the lens subassembly. The powered subcomponent may be an LED subsystem. The LED subsystem may include at least one LED. The LED subsystem may be removeable from the lens subassembly. The wire harness may conduct electricity from the electrical system of the vehicle to the LED subsystem.

The cover connector may include one or more housing fasteners that engage the housing and secure the cover connector to the housing such that the opening is closed by the cover connector. The housing fasteners may selectively engage the housing when the cover connector is in a first position attached to the housing. The opening may be sealed (e.g., resist incursion of moisture, dust, etc.) while the cover connector is in the first position. The housing fasteners may disengage the housing when the cover connector is in a second position detached from the housing. The wire harness may have a length sufficient to extend out of the opening of the housing when the cover connector is detached from the housing (i.e., in the second position). The opening may be accessible (e.g., the wire harness, a replaceable component of the lens subassembly, etc. may be accessed or manually reached through the opening) when the cover connector is in the second position. Thus, the cover connector may enable replacing the powered subcomponent with a replacement powered subcomponent without disassembling or replacing the entire light system.

The cover connector may include one or more connector fasteners that selectively engage the wire harness and secure the cover connector to the wire harness such that the one or more electrical conductors are electrically accessible through the cover connector while the cover connector is secured to the housing. The one or more connector fasteners may be configured to selectively connect to and disconnect from the wire harness. The cover connector may include a socket configured to hold the wire harness and secure the cover connector to the wire harness. The connector fasteners may selectively connect and disconnect from the wire harness. That is, the cover connector may be attached to the wire harness when the connector fasteners are engaged with the wire harness and detached from the wire harness when the connector fasteners are disengaged from the wire harness.

The cover connector may be pivotably attached to the housing. The cover connector may pivot between an open position and a closed position. The opening may be accessible when the cover connector is in the open position. That is, the opening may be accessible (e.g., the wire harness, a replaceable component of the lens subassembly, etc. may be accessed or manually reached through the opening) when the cover connector is in the open position. The opening may be sealed (e.g., resist incursion of moisture, dust, etc.) when the cover connector is in the closed position. Thus, the pivotable attachment may enable the replacement of a powered subcomponent without detaching the cover connector from the housing.

A method of assembling a light system may include extending the wire harness from a powered subcomponent through the opening in the housing. The extending may include extending the wire harness through the opening a selected distance outside of the housing. Thereafter, the cover connector may be connected to the wire harness. Thus, connecting the cover connector to the wire harness may occur after extending the wire harness through the opening. When the cover connector is applied or otherwise secured to the housing, the wire harness may be enclosed within the light system. Therefore, the enclosing may occur after the connecting.

The method may include mounting a powered subcomponent with respect to the housing. The mounting may occur before connecting the cover connector to the wire harness. Thus, the lens subassembly may be secured (e.g., fastened, welded, bonded using a sealant or adhesive, etc.) to the housing before the wire harness is connected to the cover connector and the cover connector is applied or otherwise secured to the housing.

The method may include removing the cover connector from the housing to replace or repair the powered subcomponent or some portion or component thereof. Removing the cover connector from the housing may occur after the enclosing. The method of removing the cover connector may be separate and distinct from the method of manufacturing or assembling the light system. That is, the method may be a repair or replacement method that is completed after (e.g., long after) the method of manufacturing or assembling the light system has been completed. The removing may occur after the enclosing. The method may include replacing the powered subcomponent with a replacement powered subcomponent. The replacing may occur after the removing. The method may include attaching the wire harness to an electrical system of a vehicle. The attaching may occur after the enclosing. Thus, a powered subcomponent may be replaced after the housing is connected (i.e., bonded) to the lens subassembly. For example, a LED may be replaced in the light system (e.g., a headlight) after the light system is manufactured (e.g., after the light system has left a manufacturing facility, by the end user, etc.).

The foregoing elements and features can be combined in various combinations without exclusivity, unless expressly indicated otherwise. These elements and features, as well as the operation thereof, will become more apparent in view of the following detailed description with accompanying drawings. It should be understood that the following detailed description and accompanying drawings are intended to be exemplary in nature and non-limiting.

### BRIEF DESCRIPTION OF THE DRAWINGS

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1 is a side view of a vehicle including a light system.

FIG. 2 is a box diagram of the vehicle of FIG. 1 including a light system and an electrical system.

FIG. 3A is a schematic illustration of the light system before the opening has been sealed.

FIG. 3B is a schematic illustration of the light system while the opening is being sealed.

FIG. 3C is a schematic illustration of the light system after the opening has been sealed.

FIG. 4A is a schematic illustration of the light system before the opening has been sealed.

FIG. 4B is a schematic illustration of the light system while the opening is being sealed.

FIG. 4C is a schematic illustration of the light system after the opening has been sealed.

FIG. 5 is a partially exploded view of the light system.

FIG. 6 is a bottom perspective view of the housing of FIG. 5.

FIG. 7 is an exploded view of a cover connector and a wire harness.

FIG. 8 is a cross-sectional view of the cover connector disconnected from the wire harness and cut along line VIII-VIII of FIG. 8.

FIG. 9 is a cross-sectional view of the cover connector connected to the wire harness.

FIG. 10 is a flow diagram of a method of assembling the light system.

FIG. 11 is a flow diagram of a method of assembling the light system.

FIG. 12 is a flow diagram of a method of assembling the light system.

### DETAILED DESCRIPTION

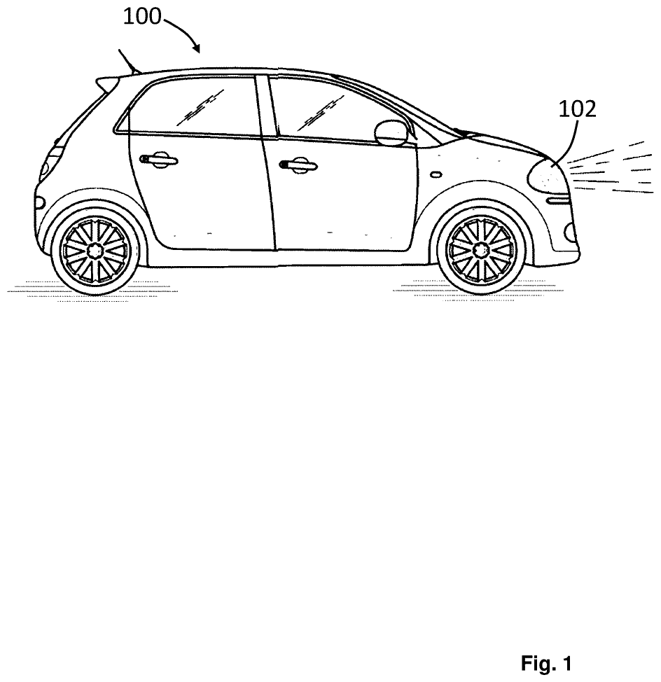

FIG. 1 is a side view of a vehicle 100. The vehicle 100 may include a light system 102 (e.g., headlight, brake light, etc.). The light system 102 may affect the functionality, safety, and design of the vehicle 100. For example, the light system 102 may provide visibility at night or during adverse weather conditions (i.e., fog, rain, or snow). Additionally, the light system 102 may assist the driver in avoiding obstacles (i.e., pedestrians, animals, other vehicles, or a combination thereof). The light system 102 may be designed to meet safety standards. Further, the light system 102 may be a part of the vehicle's design.

The design of the vehicle 100 is a blend of functionality and aesthetics, reflecting both practical needs and consumer stylistic preferences. Functionally, the vehicle 100 may have some performance criteria, including fuel efficiency, safety standards, and ergonomic comfort for passengers. Engineers configure components such as the chassis, engine, and aerodynamics to optimize these aspects. Aesthetically, the appearance of the vehicle 100 plays a role in market appeal, influencing consumer choices and brand identity. Designers craft the vehicle's lines, color schemes, and overall silhouette to evoke emotions and convey luxury, sportiness, reliability, or a combination thereof. This dual focus on practicality and visual impact ensures that the vehicle 100 is not only operational and safe, but appealing to the eye, catering to both the practical needs and aesthetic desires of consumers.

The shape and configuration of the light system 102 of the vehicle 100 illustrate the balance between functionality and aesthetics within automotive design. Functionally, the light system 102 is critical for visibility. The light system 102 may be a headlight, a tail light, a brake light, a turn signal, a running light, a signature light, or a combination thereof. The light system may perform lighting functions including signaling, low beam, a high beam, or a combination thereof. The shape and placement of the light system 102 may vary a range and an intensity of light, adhering to safety regulations that ensure they effectively illuminate the road ahead without blinding oncoming traffic. This may use precise engineering to optimize the angles and dispersion patterns of light. Aesthetically, the design of the light system plays a significant role in defining the vehicle's exterior and can significantly influence a vehicle model's visual identity. Designers often use the light systems 102 to introduce innovative styles, such as sleek, narrow shapes for a modern look or distinctive configurations that echo a brand's historical design cues. Thus, the design of the light system 102 is an example of how functionality is integrated with stylistic expression to meet both operational demands and consumer preferences.

The manufacturing process of a light system 102 of a vehicle 100 can be influenced by both the functional and aesthetic design factors that dictate their form and functionality. On a functional level, the production techniques ensure that light systems are capable of withstanding environmental factors (e.g., heat, cold, moisture, or the like) while maintaining optimal light output and distribution. A precise assembly process can ensure airtight sealing and alignment of the internal components. Aesthetically, the manufacturing process may be capable of producing the intricate shapes and finishes dictated by the vehicle's design, often requiring advanced molding, machining, and tolerancing technologies to achieve the contours designers envision. Additionally, the method may allow various colors or textures for brand differentiation or stylistic flair. Thus, the manufacturing of the light system 102 of the vehicle 100 is a sophisticated process that may closely align design specifications to meet both aesthetic desires and functionality.

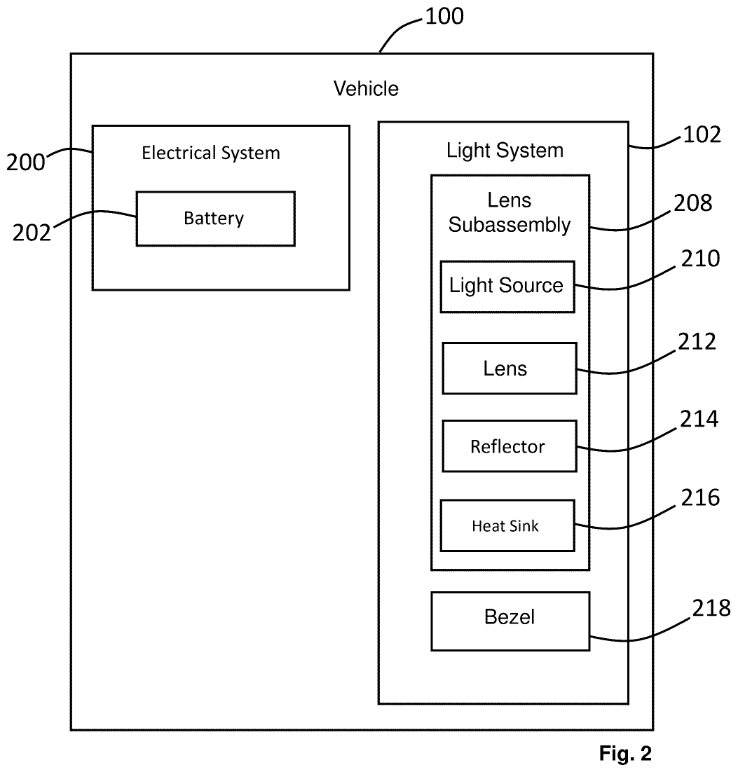

FIG. 2 is a box diagram of the vehicle 100. The vehicle 100 may have multiple systems including an electrical system 200 and a light system 102 (e.g., the headlight). The electrical system 200 in a vehicle may power and control multiple functions (e.g., starting the engine, operating lights, operating electronic devices, or the like). The electrical system 200 may include a battery 202, which supplies the electrical charge to start the engine and provide power to the electrical components of the vehicle 100 when the engine is not running. The electrical system 200 may distribute electricity throughout the vehicle to other subsystems (e.g., light system 102).

The electrical system 200 may power the light system 102. The light system 102 may be located within the vehicle 100. The light system 102 may be a part of the vehicle 100. Vehicle 100 may a car, motorcycle, bus, truck, semi-truck, sport utility vehicle (SUV), crossover utility vehicle (XUV), four-wheeler, dirt bike, tractor, combine, heavy equipment, farm equipment, industrial equipment, commercial equipment, or a combination thereof. The light system 102 may project in a forward direction, rear direction, side direction, or a combination thereof. The light system 102 may project a light from an external surface of the vehicle 100 to a location in front of the vehicle or at an angle relative to the front of a vehicle. The light system 102 may direct light at the ground. The light system 102 may direct light above the ground. The light system 102 may be integrated into a front end, a rear end, or both of a car. The light system 102 may project light out of the vehicle.

The light system 102 may include a lens subassembly 208. The lens subassembly 208 may include one or more light sources 210. The one or more lights sources 210 may be any type of lighting device that produces light such as an incandescent bulb, fluorescent light, compact fluorescent lamp, halogen lamp, light emitting diode (LED), high intensity discharge lamps (HID), halogen lights, xenon lights, a laser diode, phosphorous bulb, or a combination thereof. The light source 210 may be a single lamp or bulb. The light source 210 may be a part of a set of light sources that includes a plurality of lamps, bulbs, diodes, or a combination thereof. The light source 210 may be part of a set of light sources that includes two or more, 3 or more, 4 or more, or 5 more light sources that produce light and combine together to form the light extending from the light system. The sets of light sources may include 50 or less, 35 or less, 20 or less, or 15 or less devices that produce light (e.g., each set may include 5 light sources or alternatively all of the sets when combined together may include 5 light sources). For example, the set of light sources may be the contents of a single printed circuit board that perform a same lighting function and the set of light sources may be 5 light sources. The set of light sources may be all of the light sources on all of the printed circuit boards that create a same lighting function and may be 15 light sources. For example, there may be 30 total light sources, but only 15 perform a same function and those may be a set of light sources. The light source 210 may be static. The light source 210 may be free of movement. The light source 210 may be manually or physically adjusted so that the light source 210 is directed to a desired location. The light source 210 may be fixed and the light from the light source 210 may be moved, bent, directed, or a combination thereof.

The one or more light sources 210 may function to produce light. The one or more light sources 210 may be a singular device or a plurality of devices that create light and the light extends outward from the one or more light source 210. The one or more light sources 210 may produce a high beam, a low beam, a blending beam, a running light, a daytime light, a turn signal, a brake light, or a combination thereof. The one or more light sources 210 may be aimed for near light, far light, blending light that blends the far light and near light together, or a combination thereof. The one or more light sources 210 may have different functions. For example, one light source may provide a running light and another light source may be a turn signal or fog light. The light source may include a plurality of lights or may be a single light source within a set of light sources. The plurality of lights may be in one set or group of light sources 210. The light source 210 may be a single light that projects light. A single instance of a light source 210 may direct light to a first location. The one or more light sources 210 may be directional light. The one or more light sources 210 may have an emission that is a Lambertian emission or a narrow emission angle. The directional light source may concentrate light on a light guide, towards a light bar, a reflector, or a combination thereof. The one or more light sources 210 may include a laser diode, glowing phosphor, filament bulb, a LED, a halogenated light, an xenon light, or a combination thereof.

The lens subassembly 208 may include one or more lenses 212. The one or more lenses 212 may function to form an outermost surface of the light system 102 (e.g., an outer lens). The one or more lenses 212 may focus and direct the light emitted from the light source 210. The one or more lenses 212 may reflect light to spread the light over an area around the vehicle (e.g., forward of the vehicle, along a side of the vehicle, or both). The one or more lenses 212 may refract light into a controlled spread that illuminates the road ahead without blinding oncoming traffic. The one or more lenses 212 may include a curvature to direct light to assist in driving in adverse conditions (e.g., rain, snow, fog, or the like). The one or more lenses 212 may protect the light system 102. The one or more lenses 212 may be clear.

The lens subassembly 208 may include a reflector 214. The reflector 214 may function to direct or redirect light from a light source to a location external of the light system, vehicle, or both. The reflector 214 may be aimed. The reflector 214 may be sized and shaped to direct light to a predetermined region or location. The reflector 214 may be moved about 1 or more locations, two or more locations, three or more locations, or even four or more locations. The locations may be in line with one another or within a plane. The locations may form a triangle, a square, a rectangle, or a combination thereof. The reflector 214 housing may include a primary reflector surface, a secondary reflector surface, or both.

The lens subassembly 208 may include a heat sink 216. The heat sink 216 may manage the temperature of other components (i.e., one or more of the light sources 210, one or more of the lenses 212, etc.). The heat sink 216 may prevent overheating of the lens subassembly 208 and may thereby extend the life of the lens subassembly 208. For example, the LED subsystem may produce heat during use and the heat sink 216 may absorb the heat produced by the LED subsystem disperse it into the surrounding environment.

The light system 102 may include a bezel 218. The bezel 218 may frame the housing. The bezel 218 may protect the housing and internal components (i.e., the light source 210, reflectors 214, or the like) from external elements (i.e., dirt, moisture, or debris). The bezel 218 may also provide stability to the light system 102 by preventing misalignment due to various stresses (e.g., vibrations). The bezel 218 may be designed to match brand styling of the vehicle 100.

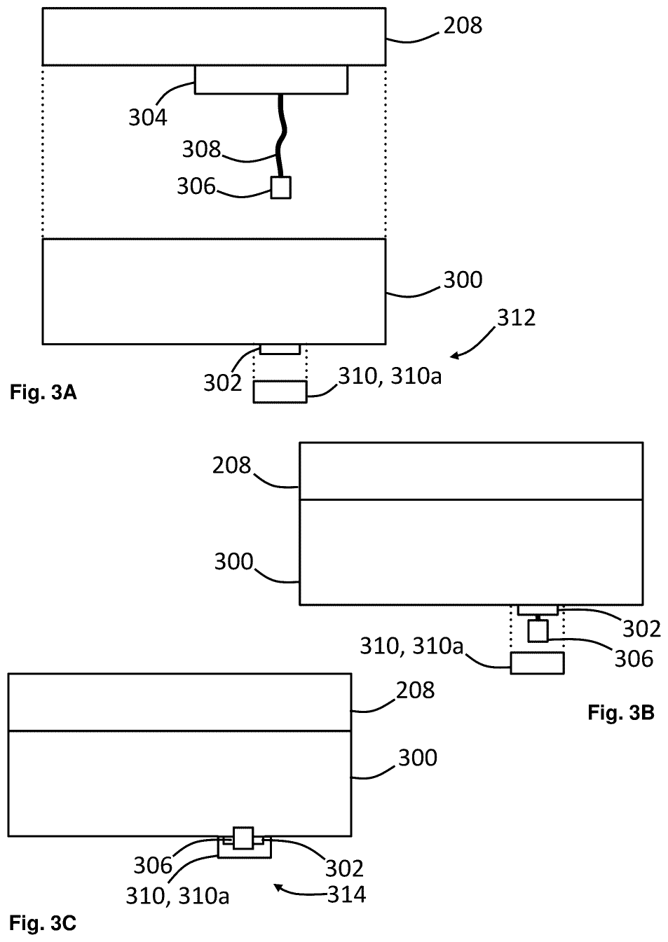

FIG. 3A is a schematic illustration of a light system 102 before the opening has been sealed. The light system 102 may further include a housing 300 with an opening 302, a powered subcomponent 304, a wire harness 306, and the cover connector 310. In use, the wire harness 306 may extend from the lens subassembly 208 and connect to the cover connector 310 such that the wire harness 306 is still accessible (i.e., able to be connected to the electrical system 200) when the cover connector 310 is attached to the housing 300. The wire harness 306 may extend from the powered subcomponent 304 located within the lens subassembly 208 and connect to the cover connector 310 such that the wire harness 306 is still accessible when the cover connector 310 is attached to the housing 300.

The powered subcomponent 304 may be a LED subsystem, a printed circuit board, or a combination thereof. The powered subcomponent may be attached (e.g., electrically connected, adhered, bonded, etc.) to the lens subassembly 208. The powered subcomponent 304 may be the mounted on the heat sink 216 to enable the cooling of the powered subcomponent 304. The powered subcomponent 304 may be aligned with the reflector 214 or lenses 212 to direct the onto the road, providing visibility for the driver. The placement of the powered subcomponent 304 may also enable access for maintenance or replacement without disassembling the entire light system.

The housing 300 may be installed in the vehicle 100. The housing 300 may protect and support the lighting components (i.e., one or more of the lenses 212, reflector 214, heat sink 216, etc.). The housing 300 may be secured (e.g., fastened, welded, bonded using a sealant or adhesive, etc.) to the lens subassembly 208. The housing 300 may be made of a polycarbonate plastic. The housing 300 may be made of a thermoplastic polymer, a thermosetting polymer, or a combination thereof. The housing may be made of a metal (e.g., an aluminum alloy, a magnesium alloy, or the like). The housing 300 may include an opening 302 extending through the housing 300 to an exterior of the housing 300. The opening 302 may be defined by the interior of the housing 300. That is, the interior of the housing 300 may be accessed through the opening 302. The opening 302 may allow for the installation and removal of the powered subcomponents 304, the routing of electrical wiring, the integration of ventilation systems, or a combination thereof. The opening 302 may facilitate access to the powered subcomponents 304 of the light system 102 for maintenance or replacement, ensuring that powered subcomponents 304 can be removed, replaced, or checked without the need to dismantle the entirety of the light system 102.

The light system 102 may include a wire harness 306. The wire harness 306 may include one or more electrical conductors 308. The wire harness 306 may connect and interface to the powered subcomponent 304 (i.e., a LED subsystem) allowing for secure and reliable connections. The wire harness 306 may include a selected length capable of extending a selected distance outside of the housing 300. The selected length may be a sufficient length so that the wire harness 306 may include slack (e.g., a length so that the wire harness 306 may extend out of the housing a distance of about 5 cm or more, 10 cm or more, 20 cm or more, or about 50 cm or less). The slack may allow the wire harness 306 to be expanded and contracted during assembly, repair, installation, or a combination thereof. The slack may compensate movement and vibration of the connected powered subcomponent 304 by reducing the strain on the connection to the powered subcomponent 304. The slack may provide flexibility during the installation process enabling easier routing of the wire harness 306. The slack may assist in adjustments or repairs. The wire harness 306 may extend from the powered subcomponent 304 in the lens subassembly 208 through the opening 302 in the housing 300 the selected distance outside of the housing 300. The selected distance may be a distance that allows the connections (i.e., connection to the electrical system 200, connection to the powered subcomponent 304, etc.) to be made with minimal disruption to the light system 102. The wire harness 306 may be connected to the electrical system 200 of a vehicle to provide electricity to the powered subcomponent 304. In use, the wire harness 306 may have enough slack to extend out of the opening 302 to be available for connection to the electrical system 200 of the vehicle 100. For example, when the wire harness is connected to the electrical system 200 of the vehicle 100, the wire harness 306 may be configured to conduct electricity from an electrical system 200 of the vehicle to the LED subsystem (i.e., the powered subcomponent 304.) That is, electricity may pass from the electrical system 200 through the electrical conductors 308 to the LED subsystem, thus enabling the power the LED subsystem to produce light.

The light system 102 may further include a cover connector 310. The cover connector 310 may seal the opening 302 from contaminants (i.e., dust, debris, fluids, or the like) by a sealing member (e.g., an O-ring, gasket, or the like). The cover connector 310 may be made of rubber, silicon, a thermoplastic elastomer, any suitable material, or a combination thereof. The cover connector 310 may attach to the wire harness 306. For example, the cover connector 310 may be placed on the opening 302 of the housing 300 after the wire harness 306 is extended through the opening 302 of the housing 300 such that the cover connector 310 can connect to the wire harness 306 while the wire harness 306 is within the opening 302.

The cover connector 310 may be a cap 310a. The cap 310a may selectively attach (i.e., in a first position 312) over the opening 302 of the housing 300. The cap 310a may selectively detach (i.e., in a second position 314) from the housing 300. The cap may seal the opening 302 of the housing 300 from contaminants in the first position 312. The cap may be disconnected from the opening 302 in the second position 314. The opening 302 may be accessible (e.g., the wire harness 306, a replaceable component of the lens subassembly, etc. may be accessed or manually reached through the opening) in the second position 314. For example, the wire harness 306 may be extended through the opening 302 and attach to the cap 310a. The cap 310a may then be secured to the housing 300 to seal the opening 302.

FIG. 3B is a schematic illustration of the light system 102 while the opening is being sealed. For example, the cap 310a may attach to the wire harness 306 while the wire harness 306 is outside of the opening 302. The slack in the wire harness 306 may enable the wire harness 306 to extend the selected length outside of the opening 302. For example, the wire harness 306 may extend a selected length outside of the housing 300 to enable the connection of the cap 310a to the wire harness 306. The cap 310a may attach to the wire harness 306 while the wire harness 306 is within the opening 302. The cap 310a may be detached from the housing 300 while the cap is attached to the wire harness 306.

FIG. 3C is a schematic illustration of the light system 102 after the opening has been sealed in the first position 312. The cap 310a is shown in transparent for illustration purposes. For example, the cap 310a may attach to the housing 300. The cap 310a may close the opening 302 such that the wire harness is within the opening. The wire harness 306 may be accessible (i.e., able to be connected to the electrical system 200) while the cap 310a is attached to the housing. The cap 310a, while connected to the wire harness 306, may be moved such that the wire harness 306 is positioned within the opening 302. Thus, the slack may enable the wire harness to be position within housing once the cap 310a is connected to the housing 300. The cap 310a may seal the opening 302 when attached to the housing 300. Both the wire harness 306 attached to the cap 310a and the cap 310a attached to the housing may seal the opening 302.

The light system may include a structure (e.g., a cover, a vehicle interface, a mounting panel, etc.). The enclosure may include an opening 302. The enclosure may enable the light system to mount directly to the vehicle or the front-end module (FEM). The structure may include an opening 302 such that the wire harness 306 may be extended through the opening 302 and attach to the cap 310a. The cap 310a may then be secured to the housing 300 to seal the opening 302. Both the wire harness 306 attached to the cap 310a and the cap 310a attached to the enclosure may seal the opening 302.

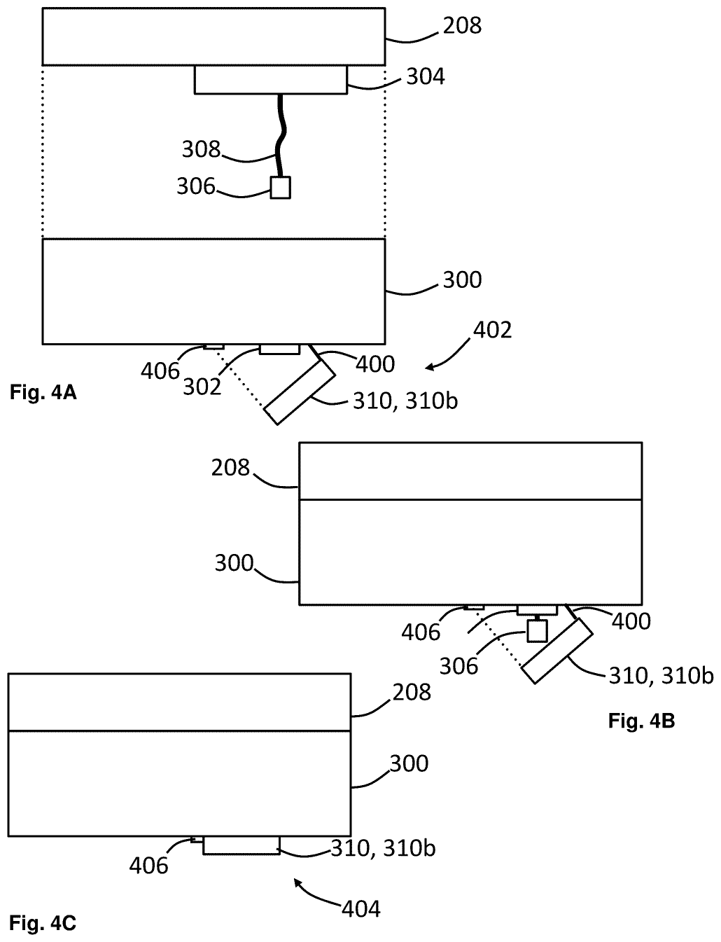

FIG. 4A is a schematic illustration of the light system 102 before the opening has been sealed. The cover connector 310 may be a door 310b attached to the housing 300. The door 310b may be attached to the housing by a pivot 400. The door 310b may be positioned adjacent to the opening 302. The pivot 400 may be positioned above or below the opening 302. The door 310b may be positioned to a side (i.e., left or right) of the opening 302. The door 310b may pivot between an open position 402 wherein the opening 302 is accessible (e.g., the wire harness, a replaceable component of the lens subassembly, etc. may be accessed or manually reached through the opening) and a closed position 404 wherein the opening 302 is closed.

FIG. 4B is a schematic illustration of the light system 102 while the opening 302 is being sealed. For example, the door 310b may attach to the wire harness 306 while the wire harness 306 is outside of the opening 302. The door 310b may attach to the wire harness 306 while the wire harness 306 is within the opening 302. The door 310b may be detached from a portion of the housing 300 while the cap 310a is attached to the wire harness 306. For example, the wire harness 306 may extended a selected length outside of the housing 300 to enable the connection of the door 310b to the wire harness 306. The door 310b, while connected to the wire harness 306, may be moved such that the wire harness 306 is positioned within the opening 302.

FIG. 4C is a schematic illustration of the light system 102 after the opening 302 has been sealed and the door 310b is in the closed position 404. In the closed position 404, the door 310b may seal the opening 302 from contaminants. The door 310b may include a lock 406 positioned opposite the pivot 400. For example, the wire harness 306 may extend through the opening 302 and attach to the door 310b. The door 310b may then lock to secure the door 310b to the housing 300 to seal the opening 302. Both the wire harness 306 attached to the door 310b and the door 310b secured to the housing may seal the opening 302. For example, the door may pivot from an open position 402 to the closed position 404 to close and seal the opening 302

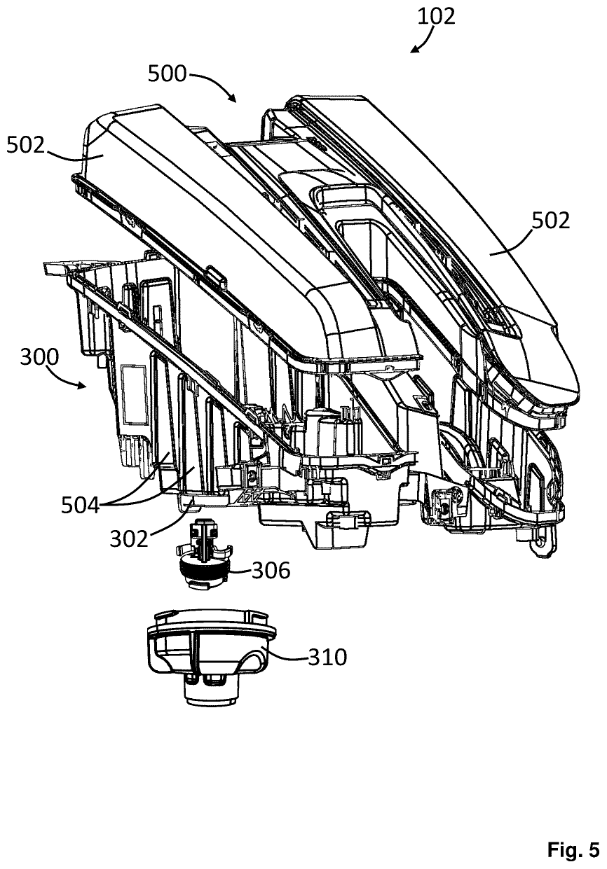

FIG. 5 is a partially exploded view of the light system 102. The lenses 212 may be an outer lens 500 (e.g., a headlight cover). The outer lens 500 may protect the internal components of the headlight (i.e., the light source 210, reflectors 214, or the like) from external elements (i.e., dirt, moisture, or debris). The outer lens 500 may be made of polycarbonate, acrylic, any other suitable material, or a combination thereof. The outer lens 500 may be treated with coatings to resist scratching and hazing. The outer lens 500 may include textural designs or patterns that aid in directing the light. The outer lens 500 may include one or more loaves 502. The loaves 502 may each contain one or more light sources 210. The loaves 502 may focus and direct light.

Each opening 302 may be sealed by a cover connector 310. The cover connectors 310 may all be caps 310a. The cover connectors 310 may all be doors 310b. The cover connectors 310 may be a combination of caps 310a and doors 310b. Each opening may have a wire harness 306 extend therethrough. Each opening 302 may correspond to a different instance of a powered subcomponent 304. For example, a first opening 302a may be used to connect a first LED subsystem to the electrical system 200 of the vehicle 100. Similarly, a second opening 302b may be used to connect a second LED subsystem to the electrical system 200 of the vehicle 100.

The housing 300 may include ribs 504. The ribs 504 may be a structural component that provides rigidity to the light system 102 from various stresses (e.g., vibrations or flexing). The ribs 504 may be molded to the housing 300. The ribs 504 may dissipate heat generated by the light source 210 by increasing the surface area in the interior of the housing 300 and enhancing air circulation within the light system 102. The ribs 504 may assist in directing the light produced by the light system 102 through the outer lens 500. The ribs 504 may help maintain the correct alignment of the lens subassembly 208 by stiffening the housing 300.

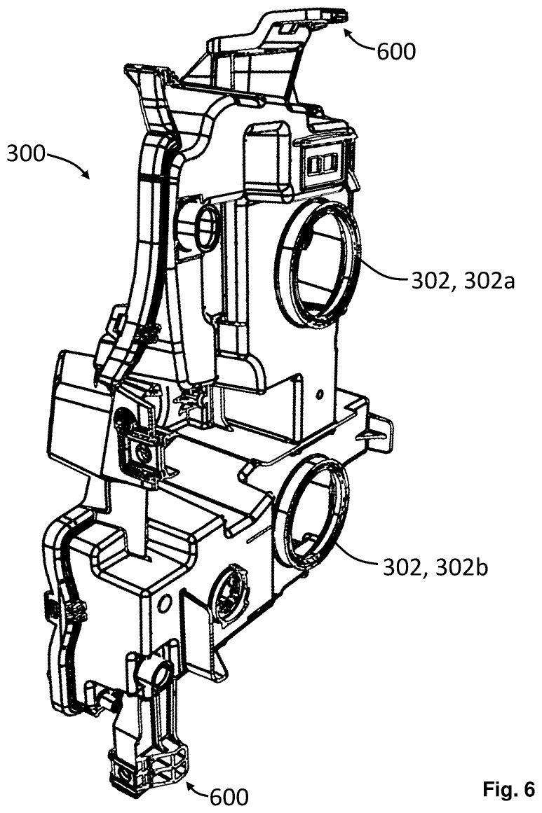

FIG. 6 is a bottom perspective view of the housing 300. The housing 300 may include more than one opening 302. For example, a first opening 302a may be used to connect a first LED subsystem to the electrical system 200 of the vehicle 100. Similarly, a second opening 302b may be used to connect a second LED subsystem to the electrical system 200 of the vehicle 100.

The housing 300 may include mounting attachments 600. The mounting attachments 600 may fix the light system to the vehicle 100. The mounting attachments 600 may enable the attachment of the housing 300 via a fastener (e.g., brackets, clips, screws, adhesive, etc.) to the vehicle. The mounting attachments 600 may prevent movement of the light system 102 relative to a vehicle that could lead to misalignment of the light system 102 relative to the vehicle. The mounting attachments 600 may integrate the light system 102 with the design of the vehicle 100. That is, the mounting attachments 600 may connect to the body of the vehicle 100 to secure the light system 102 in place. For example, a headlight (i.e., the light system 102) may be mounted within the body of vehicle 100 by securing the mounting attachments 600 to the body of vehicle 100.

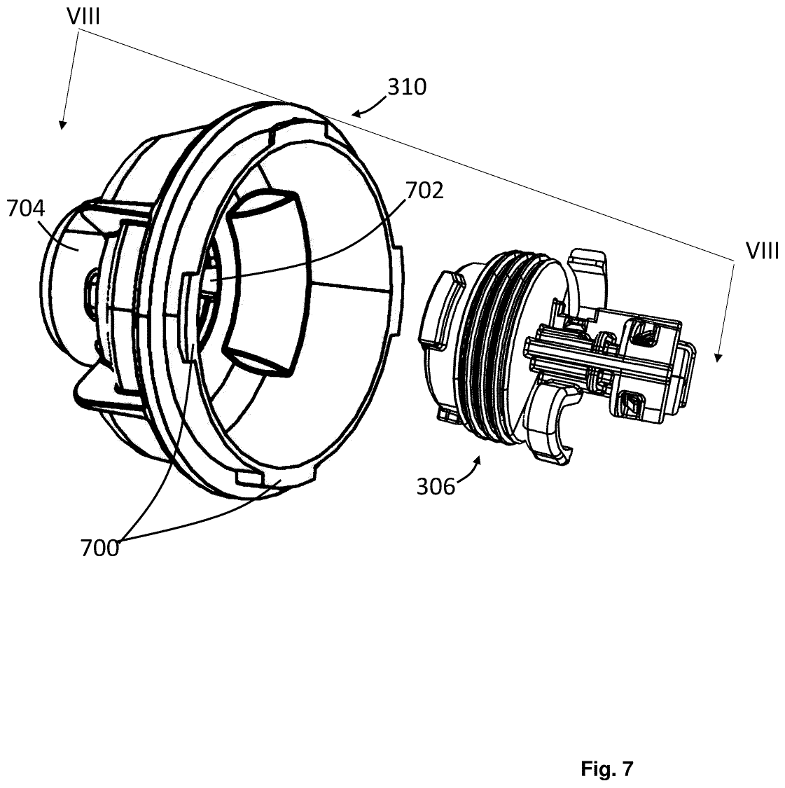

FIG. 7 is an exploded view of the cover connector 310 and the wire harness 306. The cover connector 310 may include one or more housing fasteners 700 (e.g., a quarter turn connection, threaded connection, etc.). The housing fasteners 700 may selectively engage the housing 300 and secure the cover connector 310 to the housing 300. For example, the cover connector 310 may close the opening 302 when the housing fasteners 700 are engaged with the housing 300 (i.e., the first position 312). The opening may be accessible (e.g., the wire harness, a replaceable component of the lens subassembly, etc. may be accessed or manually reached through the opening) when the housing fasteners 700 are disengaged from the housing 300 (i.e., the second position 314). For example, the housing fasteners 700 may be disengaged from the housing 300 to allow for the removal of a powered subcomponent 304 and the insertion of a replacement powered subcomponent.

The housing fastener 700 may be a pivot 400. The pivot 400 may be connected to the housing 300. The pivot 400 may move the cover connector 310 between an open position 402 (i.e., where the opening is accessible) and a closed position 404 (i.e., where the opening is sealed). At least one instance of the housing fastener 700 may be a lock positioned opposite the pivot. The opening 302 may be accessible when the lock is disengaged from the housing 300. The opening 302 may be sealed when the lock is engaged with the housing 300.

The cover connector 310 may include one or more connector fasteners 702 (e.g., a threaded connection, a snap connection, a quarter turn, or the like). The connector fasteners 702 may selectively engage the wire harness 306. The connector fasteners 702 may secure the cover connector to the wire harness 306.

The cover connector 310 may include a socket 704. The socket 704 may include the connector fasteners 702. The socket 704 may be configured to hold the wire harness 306. The socket 704 may secure the cover connector 310 to the wire harness 306. The socket 704 may fit tightly with the wire harness 306 to seal the light system 102 from the elements (i.e., debris, moisture, etc.). The wire harness 306 may still be accessible for electrical connection to the electrical system 200 of the vehicle 100 when the wire harness is secured within the socket 704.

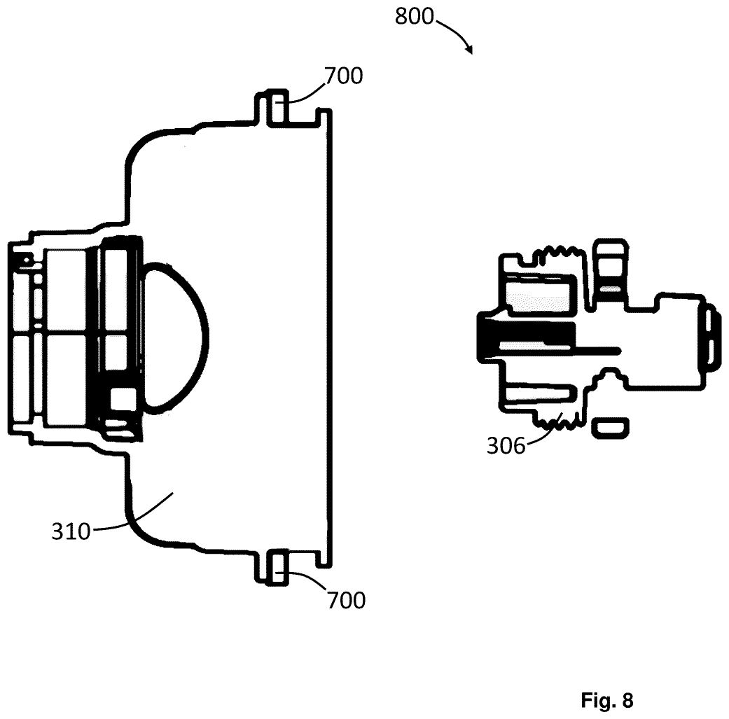

FIG. 8 is a cross-sectional of the cover connector 310 disconnected 800 from the wire harness 306. The cover connector 310 may be disconnected with the wire harness 306 when the connector fasteners 702 are disengaged from the wire harness 306. The wire harness 306 may be connected to the powered subcomponent 304 when the connector fasteners 702 are disengaged from the wire harness 306. The wire harness 306 may be disconnected 800 to the powered subcomponent 304 when the connector fasteners 702 are disengaged from the wire harness 306. In use, the cover connector 310 can be disconnected from the wire harness 306 before the cover connector 310 has been connected to the housing 300. The cover connector 310 may be disconnected from the wire harness 306 after the cover connector 310 has been connected to the housing 300.

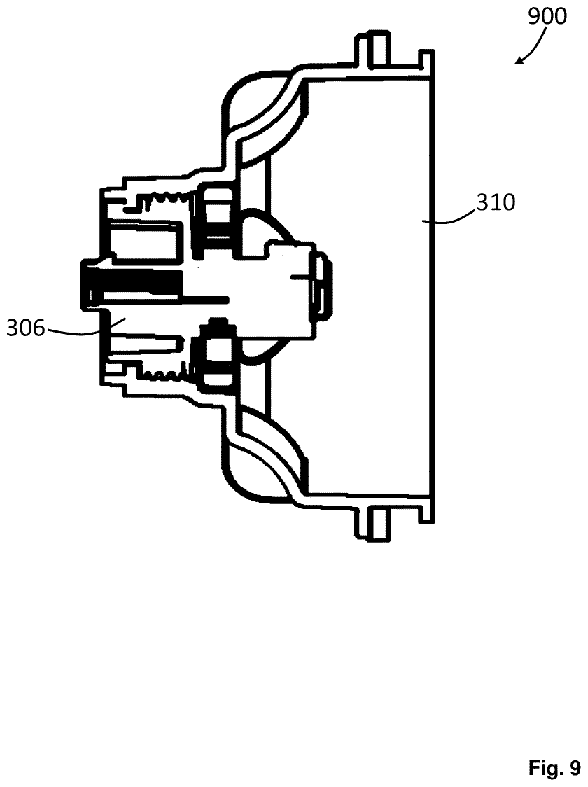

FIG. 9 is a cross-sectional view of the cover connector 310 connected to the wire harness 306. The cover connector 310 may be connected to the wire harness 306 when at least one instance of the one or more connector fasteners 702 is engaged with the wire harness 306. The wire harness 306 may be connected to the powered subcomponent 304 when the connector fasteners 702 are engaged with the wire harness 306. While the connector fasteners 702 are engaged, the wire harness 306 may be accessible through the cover connector 310 such that the wire harness 306 can be connected to the electrical system 200 of the vehicle 100. In use, the cover connector 310 may be connected to the wire harness 306 before the cover connector 310 is attached to the housing 300. For example, the cover connector 310 may be connected to the wire harness 306 by engaging the connector fasteners 702 with the cover connector 310 and securing the wire harness 306 in the socket 704. When the cover connector 310 is connected 900 to the wire harness 306, the connection may form a watertight seal. When connected 900 to the wire harness, the cover connector 310 may then be attached to the housing 300 by engaging the housing fasteners 700 such that the wire harness 306 is positioned within the opening 302 of the housing 300. When the cover connector 310 is attached to the housing 300, the connection may seal the opening 302. The seal may be a watertight seal.

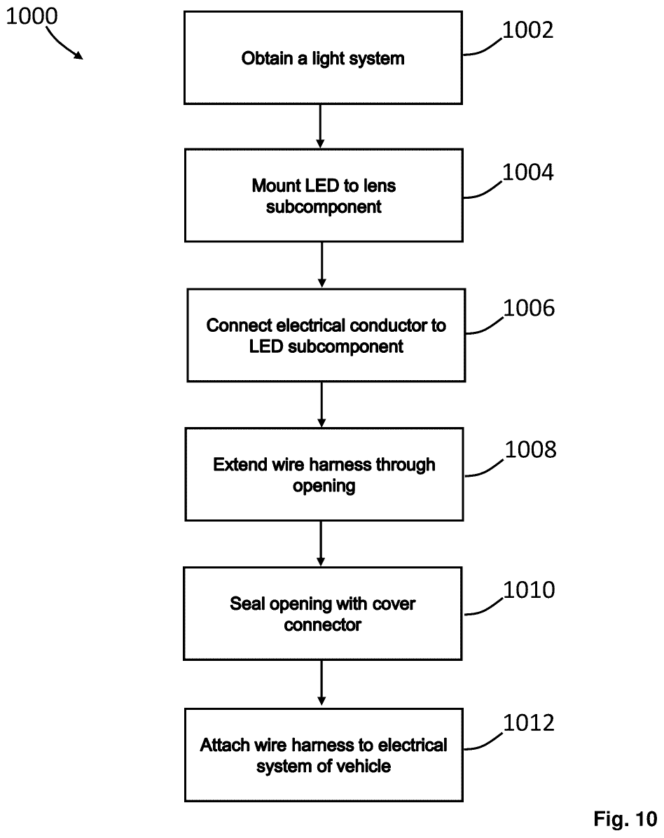

FIG. 10 is a flow diagram of a method 1000 of assembling the light system 102. The method 1000 may include obtaining 1002 a light system comprising a lens subassembly 208 including one or more light subcomponents (i.e., an LED subsystem, reflectors 214, lenses 212, heat sink 216, or a combination thereof), a housing 300 including an opening 302, a wire harness 306 including one or more electrical conductors 308, and a cover connector 310. The method 1000 may include mounting 1004 the light components to the lens subassembly 208. The method 1000 may include connecting 1006 the one or more electrical conductors 308 to at least one light subcomponent. The method 1000 may include extending 1008 the wire harness from the lens subassembly 208 through the housing 300 through the opening 302 of the housing 300. The method 1000 may include sealing 1010 the opening 302 by securing the cover connector 310 over the opening 302 of the housing 300 such that the wire harness 306 is accessible for electrical connection to the electrical system 200 of the vehicle 100. The method 1000 may include attaching 1012 the wire harness 306 to an electrical system 200 of the vehicle 100.

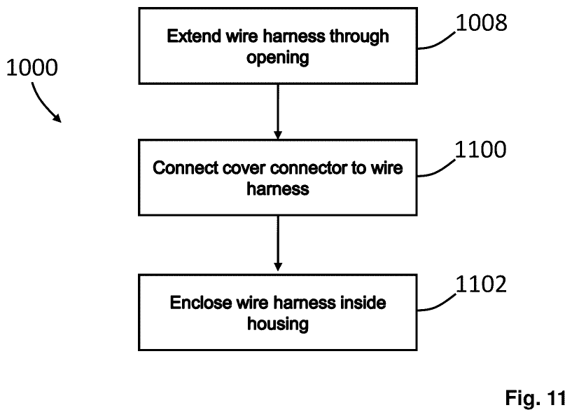

FIG. 11 is a flow diagram of a method 1000 of assembling a light system 102. The method may include extending 1008 the wire harness 306 from the lens subassembly 208 though the housing 300 and out the opening 302 of the housing 300. The method 1000 may include connecting 1100 the cover connector 310 to the wire harness 306 by engaging the connector fasteners 702 with the wire harness 306. The method 1000 may include enclosing 1102 the wire harness 306 inside the housing 300 by engaging the housing fasteners 700 with the housing 300, thereby closing and sealing the opening 302.

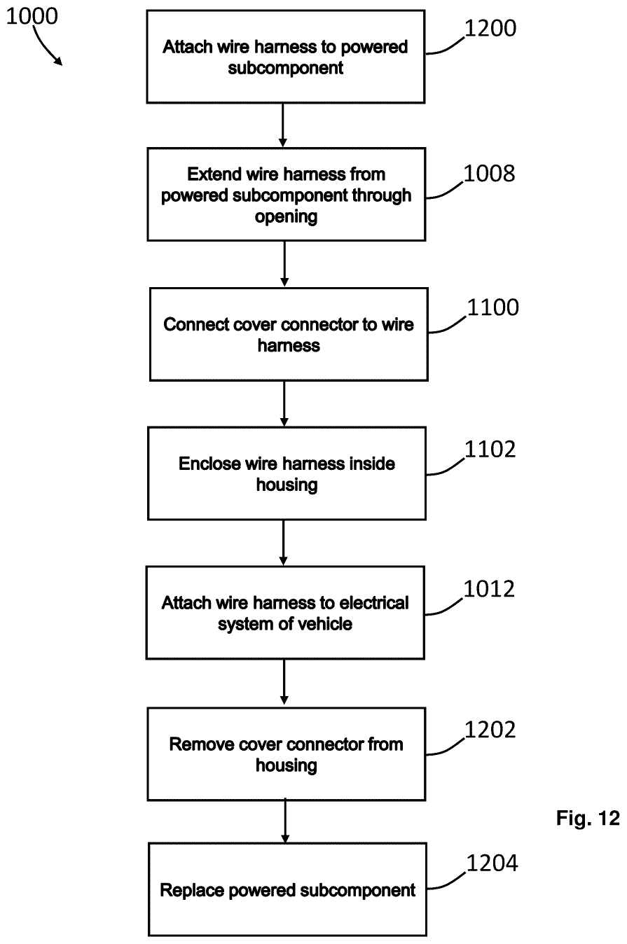

FIG. 12 is a flow diagram of a method 1000. The method 1000 may include attaching 1200 the wire harness 306 to the powered subcomponent 304 (i.e., the LED subsystem). The method may include attaching 1200 the wire harness 306 to the powered subcomponent 304. The method may include extending 1008 the wire harness 306 from the powered subcomponent 304 through the housing 300 and a selected distance out of the opening 302. The method 1000 may include connecting 1006 the cover connector 310 to the wire harness 306 by engaging the connector fasteners 702 with the wire harness 306. The method 1000 may include enclosing 1102 the wire harness 306 inside the housing 300 by engaging the housing fasteners 700 with the housing 300, thereby closing and sealing the opening 302 such that the wire harness 306 is still accessible for electrical connection to the electrical system 200 of the vehicle 100. The method may include attaching 1012 the wire harness 306 to the electrical system 200 of the vehicle 100. The attaching 1012 may occur after enclosing the wire harness 306 in the housing 300. The method 1000 may include removing 1202 the cover connector 310 from the housing 300 by disengaging the housing fasteners 700 from the housing 300. The method 1000 may include replacing 1204 the powered subcomponent 304. The replacing 1204 may include removing the powered subcomponent 304 and replacing it with a replacement powered subcomponent. For example, the LED subsystem (i.e., the powered subcomponent 304) may be replaced by removing the cover connector 310 from the housing 300 to access the LED subsystem via the opening 302, removing the LED subsystem from the lens subassembly 208, and replacing it with a new LED subsystem.

During manufacture, the wire harness 306 may be attached to the LED subsystem. The wire harness 306 may then be extended through the opening 302 of the housing 300. The housing 300 may be secured (e.g., fastened, welded, bonded using a sealant or adhesive, etc.) to the lens subassembly 208. After the wire harness 306 is bonded to the lens subassembly 208, the cover connector 310 may attach to the wire harness 306 by engaging the connector fasteners 702. After attaching the cover connector 310 to the wire harness 306, the cover connector 310 may be secured to the housing 300. The cover connector 310 may then be removed from the housing 300 for maintenance of the connections and powered subcomponents 304 without the need to dismantle or replace the entirety of the light system 102.

For example, the wire harness 306 may be attached to the lens subassembly 208. The wire harness 306 may feed through the opening 302 in the housing 300 during manufacture (e.g., a fastening process, a bonding process, etc.). After, the cover connector 310 may be connected (e.g. fastened, bonded, etc.) to the wire harness 306 such that the connection between the cover connector 310 and the wire harness 306 forms a seal. The cover connector 310, attached to the wire harness 306, may then be connected to the exterior of the housing 300 to cover and seal the opening 302. While the opening 302 is sealed, the wire harness 306 may be accessible for connection to the electrical system 200 of the vehicle 100.

The wire harness 306 may be connected to the cover connector 310 via an integrated pass-thru in the cover connector 310. For example, the wire harness 306 may plug into the integrated pass in the cover connector 310 after the wire harness 306 is attached to the lens subassembly 208. The electrical system 200 of the vehicle may connect to the wire harness 306 via an exterior of the integrated pass through (i.e., the exterior of the cover connector 310).

This process may be reversed. Thus, the cover connector 310 may be removed from the housing 300. Then, the cover connector 310 may be disconnected from the wire harness 306. After, the wire harness 306 may be disconnected from the lens subassembly 208 for maintenance, replacement, or a combination thereof of internal components (i.e., the light source 210, reflectors 214, powered subcomponent 304 or the like).

While the disclosure has been described in connection with certain implementations, it is to be understood that the disclosure is not to be limited to the disclosed implementations but, on the contrary, is intended to cover various modifications and equivalent arrangements included within the scope of the appended claims, which scope is to be accorded the broadest interpretation so as to encompass all such modifications and equivalent structures as is permitted under the law.

1. A light system comprising:
a housing configured to be installed in a vehicle, the housing comprising an interior and an opening extending therethrough;
a wire harness configured to extend from the interior of the housing through the opening to a location outside the housing, the wire harness comprising one or more electrical conductors; and
a cover connector comprising:
one or more housing fasteners engaging the housing and thereby securing the cover connector to the housing such that the opening is closed by the cover connector, and
one or more connector fasteners engaging the wire harness and thereby securing the cover connector to the wire harness wherein:
the one or more electrical conductors are electrically accessible through the cover connector while the cover connector is secured to the-housing. housing; and
the cover connector is configured to form a watertight seal with the opening when the cover connector is secured to the housing.

2. The light system of claim 1, further comprising a powered subcomponent, wherein the wire harness is connected to and extends from the powered subcomponent.

3. (canceled)

4. The light system of claim 1, wherein:
the light system further comprises a lens subassembly including a powered subcomponent;
the powered subcomponent is an LED subsystem including at least one LED; and
the wire harness is configured to conduct electricity from an electrical system of the vehicle to the LED subsystem.

5. (canceled)

6. The light system of claim 4, wherein the LED subsystem is removable from the lens subassembly.

7. The light system of claim 6, wherein the lens subassembly is secured to the housing.

8. (canceled).

9. The light system of claim 1, wherein the cover connector further comprises a socket configured to hold the wire harness and secure the cover connector to the wire harness while the wire harness is plugged into the socket.

10. The light system of claim 1, wherein;
the one or more housing fasteners selectively engage the housing when the cover connector is in a first position attached to the housing and disengage the housing when the cover connector is in a second position detached from the housing; and
the cover connector forms the watertight seal for the opening in the first position and the opening is accessible in the second position.

11. (canceled).

12. The light system of claim 10, wherein the wire harness has a length sufficient to extend out of the opening of the housing when the cover connector is detached from the housing.

13. The light system of claim 1, wherein the one or more connector fasteners are configured to selectively connect to and disconnect from the wire harness.

14. The light system of claim 1, wherein:
the cover connector is pivotably attached to the housing and pivots between an open position and a closed position; and
the cover connector in the closed position closes the opening of the housing.

15. The light system of claim 14, wherein the opening is sealed via the watertight seal in the closed position and accessible in the open position.

16. A method of assembling a light system including an outer lens, comprising:
extending a wire harness from a powered subcomponent from an interior of a housing through an opening the housing;
connecting, after the extending, a cover connector to the wire harness via a socket of the cover connector to form a watertight seal; and
enclosing, after the connecting, the wire harness inside the housing by securing the cover connector to the housing, wherein securing the cover connector to the housing forms a watertight seal over the opening and the wire harness is electrically accessible through the cover connector while the cover connector is secured.

17. The method of claim 16, further comprising mounting, before the connecting, the powered subcomponent within to the housing.

18. The method of claim 16, further comprising:
removing, after the enclosing, the cover connector from the housing; and
replacing, after the removing and without detaching the outer lens from the housing, the powered subcomponent with a replacement powered subcomponent.

19. The method of claim 16, further comprising attaching, after the enclosing, the wire harness to an electrical system of a vehicle.

20. The method of claim 16, wherein the extending further comprises extending the wire harness a selected distance outside of the housing.

21. The light system of claim 9, wherein the cover connector is configured to form a watertight seal in the socket between the wire harness while the wire harness is plugged into the socket.

22. The light system of claim 1 comprising:
a second opening extending through the housing;
a second wire harness configured to extend through the opening, the second wire harness comprising one or more electrical conductors; and
a second cover connector comprising:
one or more housing fasteners engaging the housing and thereby securing the second cover connector to the housing such that the second opening is closed by the second cover connector, and
one or more connector fasteners engaging the second wire harness and thereby securing the second cover connector to the wire harness wherein:
the one or more electrical conductors are electrically accessible through the second cover connector while the second cover connector is secured to the housing; and
the second cover connector forms a watertight seal while the second cover connector is secured to the housing.

23. The method of claim 18, wherein the removing further comprises disconnecting the wire harness from the cover connector.

24. The method of claim 16 further comprising attaching the wire harness to a powered subcomponent.
